(19) United States
(12) Patent Application Publication
(10) Pub. No.: US 2013/0306400 A1
(43) Pub. Date: Nov. 21, 2013

(54) Method of Designing and Making an Acoustic Liner for Jet Aircraft Engines

(71) Applicant: Alan S. Hersh, Calabasas, CA (US)

(72) Inventor: Alan S. Hersh, Calabasas, CA (US)

(21) Appl. No.: 13/473,550

(22) Filed: May 16, 2012

(51) Int. Cl. F02K 1/82; B23Q 17/00

(52) U.S. Cl. 181/213; 29/407.01

(57) ABSTRACT

A method for designing and manufacturing an acoustic liner for jet aircraft engines employing a spherical wedge-shaped physical model employing conservation of mass and momentum. The model has three dimensions and four empirical parameters: the location of the far-field driving acoustic pressure; the location wherein the acoustic-mean-flow is pumped into and out of the resonator volume; and two parameters that describe the acoustic-mean flow rates pumped into and out of the resonator.

### STATEMENT REGARDING FEDERALLY SPONSORED RESEARCH OR DEVELOPMENT

The U.S. Government has limited rights in this invention as provided by the terms of NASA Cooperative Agreement No. NNX10CB30C as it applies to Hersh Acoustical Engineering, Inc. This contract was awarded by the National Aeronautics and Space Administration (NASA).

### CROSS-REFERENCE TO RELATED APPLICATIONS

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates generally to the field of acoustic liners for jet aircraft engine nacelles, and more particularly to a process for designing an acoustic liner using a multi-dimensional physical model that is based upon the conservation of mass and momentum.

2. Background Art

Jet engine noise surrounding airports in congested areas has increasingly plagued aircraft and aircraft-engine manufacturers. Sound measuring equipment is present at many of the world's large airports, and fines are assessed for planes that exceed national and international noise regulations. Accordingly, optimizing the sound absorption of acoustic liners in jet engine nacelles is imperative for a new jet engine design to be commercially viable.

Acoustic liners typically comprise a honeycombed sheet with a rigid back plate and bounded by a top plate containing orifices—a resistive layer—that define a plurality of Helmholtz resonators within each honeycomb section. Existing processes for designing acoustic liners comprise costly and lengthy wind tunnel tests of various Helmholtz resonator designs to obtain data for extrapolation to generate empirical formulas to approximate liner resistance and reactance, or impedance. Liners are then designed in accordance with this extrapolated data, which are in turn tested again via trial and error by further costly and lengthy wind-tunnel tests.

While much of the specifics for the extrapolation techniques remain closely held trade secrets by nacelle manufacturers, the general process step of extrapolating data—along with severe accuracy limitations—has been outlined in some references. For example, one publication, Seing-Hyun Lee and Jeong-Guon, “Empirical Model of the Acoustic Impedance of a Circular Orifice in Grazing Mean Flow,” J. Acoust. Soc. Am. 144(1), p. 98, July 2003, states that “there are many analytical and empirical models for orifice impedance,” then presents a model that seeks to overcome “a large discrepancy with the measured result” in prior art processes. The reference continues to describe various parameters on which to focus in order to yield an “empirical impedance model by using nonlinear regression analysis of the various results of the parametric tests.” Id.

Another publication, Cecile Malmary and Serge Carbonne, “Acoustic Impedance Measurement with Grazing Flow,” American Institute of Aeronautics and Aeronautics Paper 2001-2993, 2001, p. 1-9, describes prior-art systems in which “[a]coustic impedance properties are mainly quantified by semi or totally empirical formulas, which depend on the experiment set-up used and are specific for each type of tested layer.” Id. at 1. An empirical model is then presented that includes the parameter of the boundary conditions at the treated wall.

To my knowledge, all but one model are empirical using regression analysis or some other extrapolation technique, typically using based upon the mean grazing flow in the duct. These models present an approximation for Helmholtz resonators, but require additional wind tunnel testing to optimize the design for a particular impedance goal. And any change to any parameters in the jet engine or nacelle requires retesting using a wind tunnel on various Helmholtz resonator designs. These models invariably incorporate a mean grazing flow within the duct.

In addition, these models are highly affected by the particular wind tunnel and resonator parameters such that different configurations and empirical models yield resonators that can vary in sound absorption efficiency.

One model—by the present inventor—employs a one-dimensional physical model based on conservation of mass and momentum. Hersh, A. and Walker, B, “Acoustic Behavior of Helmholtz Resonators. Part 1. Non-Linear Behavior,” AIAA Journal, Vol. 41, No. 5, May, 2003, pp. 795-808. The model is based upon a column of air that that moves into and out the resonator orifice and cavity with a non-linear spring-damping geometry. This model has the advantage that it is based on physics and physical characteristics, not merely extrapolation of data. That means that once calibrated, it may be used to calculate the impedance of a Helmholtz resonator without the need for costly and lengthy wind tunnel testing. However, this model is not practical for use in designing acoustic liners because the model is not sufficiently accurate.

More particularly, the one-dimensional model—along with the data extrapolation models—fails to account for mean-flow velocity gradients. These omissions cause the resonator designs to be less than optimal.

Accordingly, it would be desirable to develop a physical model that incorporates the physical properties of conservation of mass and momentum and is sufficiently accurate to avoid the need to conduct further wind tunnel testing required by models based on extrapolating data.

### BRIEF SUMMARY OF THE INVENTION

The present invention solves this problem by employing a model based on a three-dimensional wedge-shaped volume that pumps fluid into and out of the cavity of the Helmholtz resonator. The model—based on conservation of mass and momentum—suggests that resonator impedance may be dependent upon the local velocity gradients near the nacelle wall (i.e., the resistant layer comprising the orifices).

It is an object of the preferred embodiment of the present invention to simplify the physics and mathematics involved by limiting the model to the in-flow half cycle. This restriction is not unduly limiting because both the particle volume flow and energy pumped into and out of the resonator volume must be constant over a dynamically steady-state sound period. The success of this approach is dependent upon proper calibration of the model-derived empirical parameters with test data. The model further assumes that all resonator dimensions are small relative to the wavelength of the incident sound field to distinguish Helmholtz resonators from quarter-wave tube resonators.

It is a further object of the preferred embodiment of the present invention to use the local velocity gradients near the nacelle wall to improve upon prior-art models that use mean velocity flow in the duct. The velocity gradients very near the nacelle wall—not only the mean flow—play an important role in predicting liner impedance. Accordingly, this physical model is incorporated in a process for designing and for manufacturing acoustic liners in jet aircraft engines. It is well known in the art to begin the process of designing an acoustic liner by conducting a numerical study to determine the optimal impedance in an engine nacelle using a convective-sound propagation code.

It is another object of the invention to employ four empirical parameters of the wedge model to define the wedge volume. These parameters are the location of the far-field driving acoustic pressure; the location wherein the acoustic-mean-flow is pumped into and out of the resonator volume; the location of the maximum polar angle; and the location of the maximum azimuthal angle that define the wedge volume.

The first step in the model development is to measure the impedances of a suitable number of resonator liner configurations under a suitable number of grazing flow velocities.

The second step is to use the wedge model software to determine the four parameters that match the impedances of the test resonator liner configurations.

The third step is to derive curve-fits of the wedge model four parameters in terms of the resonator liner geometries.

The fourth step is to input the four parameter curve-fits into the wedge model software to predict resonator liner impedance as a function of liner geometry, sound pressure level and grazing flow. The validity of the software will be verified by comparing model predicted impedance to the original impedance test data. In the embodiment used for the present invention, Matlab code was employed. However, a Fortran code could be used instead, which has the advantage of being much faster than Matlab.

The fifth step is to use the wedge model software to determine liner geometry that yields the optimal, desired liner impedance. The resulting liner may be manufactured using techniques well known in the art.

### BRIEF DESCRIPTION OF THE SEVERAL VIEWS OF THE DRAWINGS

The several features and advantages of the present invention will be better understood with a reading of the following detailed description in conjunction with the following drawings, in which:

FIG. 1 shows a standard resonator liner, which is used in both prior-art systems and the preferred embodiment of the present invention, of a sandwiched construction having a rigid back-plate, a honeycomb separator, and a perforated plate or resistive layer;

FIG. 2 shows a three-dimensional view of a Helmholtz resonator with the steady-state grazing flow in a spherical coordinate system composed of radial, polar and azimuthal components in accordance with the preferred embodiment of the present invention;

FIG. 3 shows a schematic elevation view and a schematic plan view of the wedge model of the preferred embodiment of the present invention in the spherical coordinate system of FIG. 2; and

FIG. 4 shows a flow chart of the method of designing and manufacturing a Helmholtz resonator of the preferred embodiment of the present invention using a physical model employing local velocity gradients near the nacelle wall

### DETAILED DESCRIPTION OF THE INVENTION

Identical reference numerals in the drawings denote the same elements throughout the various drawings. However, the various drawings are not drawn to scale, but for illustrative purposes of the basic relative configurations.

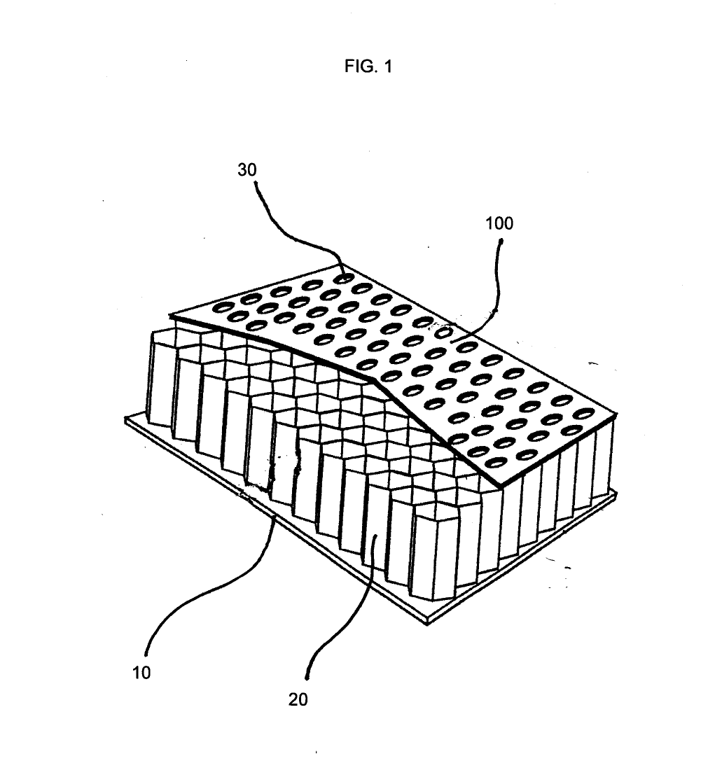

FIG. 1 shows a standard acoustic liner, comprising honeycombed cavities 20 sandwiched between rigid back plate 10 and face plate 100, which further comprises a plurality of orifices 30. Each orifice 30 does not necessarily correspond to a particular cavity 20 such that a liner may have significantly more orifices 30 than cavities 20. In conjunction with the incident flow field and sound pressure, the geometry of cavity 20 defines the impedance of the resonators, and accordingly the amount of sound absorption at a particular frequency.

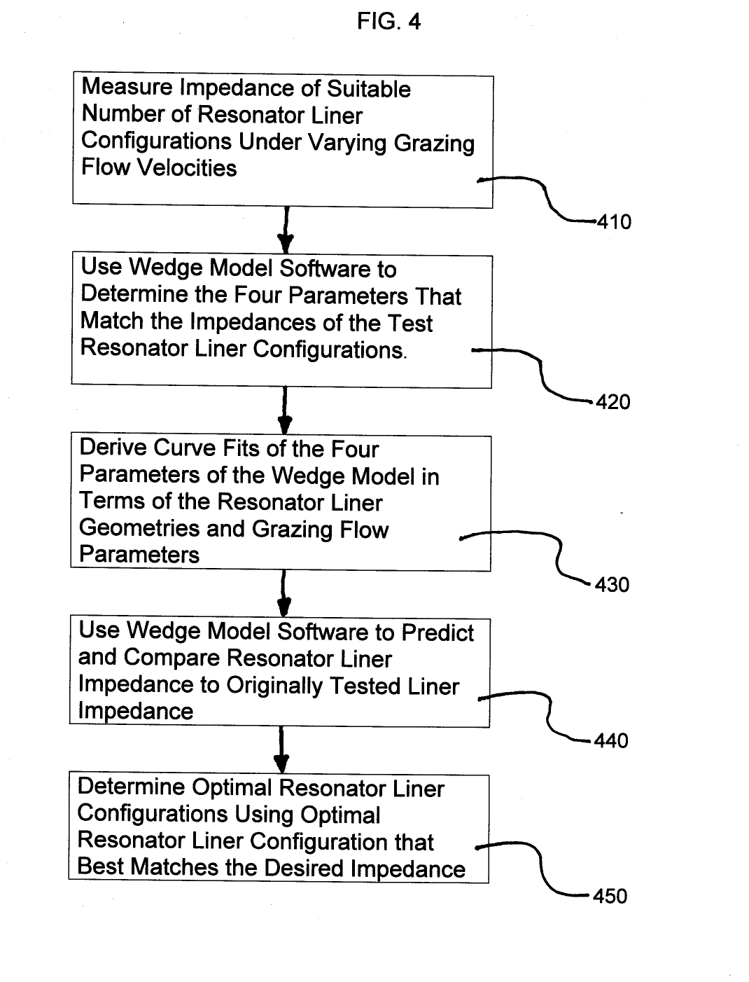

The process for designing and building an acoustic liner of the present invention is shown in FIG. 4. In first step 410, the impedances of a suitable number of resonator liner configurations are measured under a suitable number of grazing flow velocities and sound pressure levels. A suitable number of these tests may depend on feedback from test results by comparing liner predictions from test data and assessing its accuracy. This provides the data base necessary to calibrate the grazing flow wedge impedance model software. Standard practice in the art is to use empirical formulas to estimate liner acoustic performance—that is, impedance—to liner geometry, sound-pressure level and grazing flow.

Second step 420 is to use the calibration data from first step 410 in conjunction with the wedge model software to numerically compute the four empirical parameters of the wedge model that define the wedge volume: the location of the far-field driving acoustic pressure; the location wherein the acoustic-mean-flow is pumped into and out of the resonator volume; the location of the maximum polar angle; and the location of the maximum azimuthal angle that define the wedge volume.

The following procedure is used to calculate the four parameters from measured values of resistance and reactance for a particular liner configuration:
1. Arbitrarily select initial values of the model four parameters for a particular frequency.
2. Insert the initial values into the Matlab code and the predicted liner impedance, Zₚ=Rₚ+iXₚ calculated where Rₚ represents the predicted liner resistance and Xₚ the predicted liner reactance.
3. The accuracy of the predicted impedance is then compared to measured values Zₘ=Rₘ+iXₘ using the accuracy formula

$$Diff = \sqrt{{( 1 - \vert \frac{{R}_{p}}{{R}_{m}} \vert )}^{2} + {( 1 - \vert \frac{{X}_{p}}{{X}_{m}} \vert )}^{2}} ;$$

where Rₘ represents the measured liner resistance and Xₘ the measured liner reactance.
4. Systemically vary the four parameters of the model using Matlab “do-loops” and calculate Diff until Diff<0.01.
5. The above procedure is repeated for different frequencies of interest based upon the noise signature spectrum that the engine designer wishes to quiet.

Third step 430 is to derive curve fits of the four parameters from second step 420 of the wedge model that were used to determine the impedances of the liners. These curve steps connect the four parameters to all of the liner geometries used in step 410. Those skilled in the art will know how to perform this step 430.

Fourth step 440 is to input the third step 430 curve fits into the wedge model to develop software capable of accurately predicting resonator liner impedance as a function of liner geometry, sound-pressure level and grazing flow velocity. The resulting software is validated by predicting the impedances of first step 410 test resonators and comparing it to measured values. Because this model is based on physics—that is, the conservation of spherical mass and momentum, not merely an extrapolation of data—accurate predictions of impedance may be obtained without the costly and lengthy need to test a suitable number of liner configurations within a wind tunnel. In the embodiment tested, MatLab code is employed, which is shown below. Alternately, Fortran code may be used to obtain faster processing time.

At this point the nacelle manufacturer has identified the optimum impedance. Fifth step 450 is to use the calibrated wedge model software to determine the resonator geometry that matches the desired optimum resonator liner configurations and to measure the impedance of a selected resonator to confirm that it achieves the desired optimum impedance.

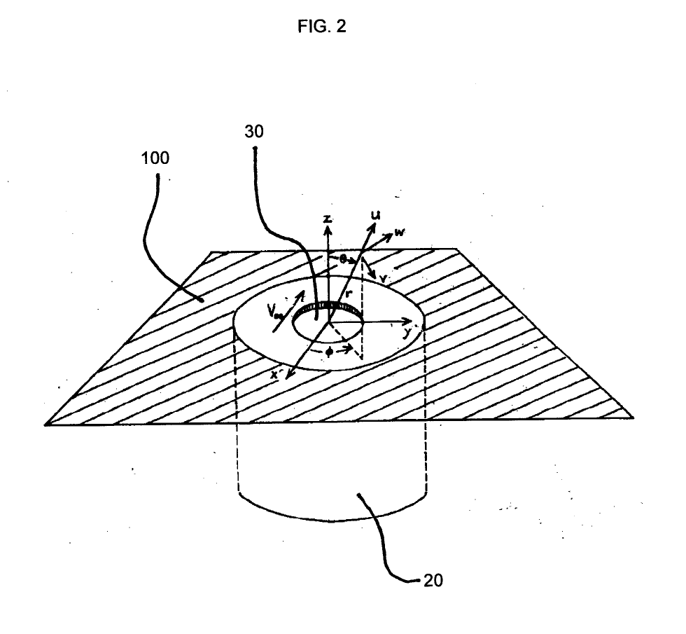

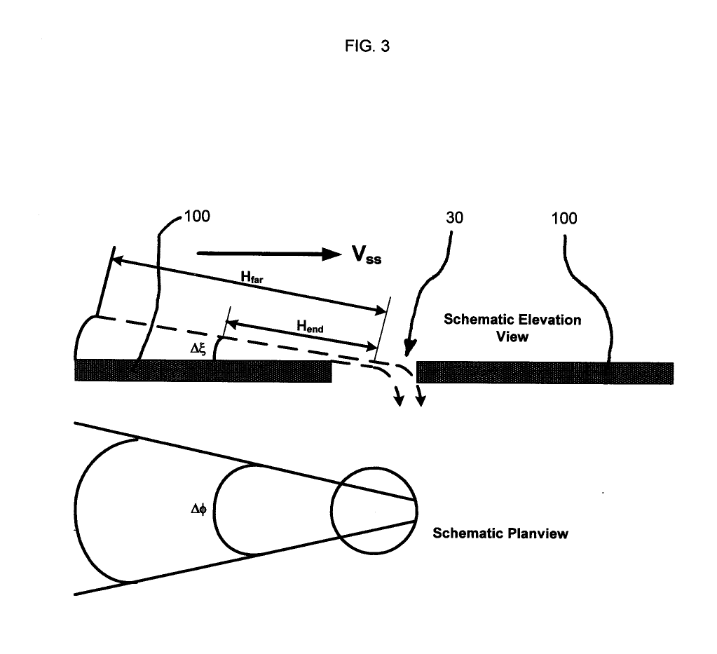

The heart of the preferred embodiment of the present invention is second step 420 to fourth step 440 in the designing process. FIG. 3 shows the wedge model, that is, an acoustic, near-field, spherical in-flow resonator impedance model. The physical model is based on a spherical wedge shown immediately above face-plate 100 in a schematic elevation view. The wedge shows fluid that is pumped into cavity 20 (not shown in FIG. 3; shown in FIGS. 1 and 2) through orifice 30. A schematic plan view in FIG. 3 shows a 2-dimensional view of the wedge more clearly.

The physical model addresses the effect of grazing flow on resonator impedance (i.e., cavity 20 bounded by face plate 100 and rigid back plate 10). The in-flow model is valid only during the half-cycle when the incident steady-state and acoustic velocities enter the resonator cavity 20—it is not valid during the other half-cycle when the acoustic flow exits the resonator cavity 20. The restriction of the model to the in-flow half-cycle is not unduly limiting because both the volume flow and energy pumped into and out of the volume of resonator cavity 20 must be constant over a dynamically steady-state sound period. Thus an approximate solution over the in-flow half-cycle should result in an approximate solution over the entire cycle. The model assumes that all resonator cavity 20 dimensions are small compared to the wavelength of the incident sound field to distinguish Helmholtz resonators from quarter-wave tube resonators, which is the case for acoustic liners in jet engines.

FIG. 2 shows the steady-state grazing flow, Vₛₛ, relative to a single resonator comprised of cavity 20, orifice 30 and face plate 100 (and rigid back plate 10, not shown), placed in a coordinate system. The decomposition of the steady-state grazing flow, Vₛₛ, is expressed in terms of the following radial, polar and azimuthal components, where the negative sign denotes spherical inflow towards resonator orifice 30,

$${{q}^{I}}_{ss} = {V}_{ss} ( z ) [ sin θcos φ , cos θcos φ , cos φ ]$$

Here, z is the height above resonator face plate 100.

FIG. 3 is a sketch that models how the boundary-layer mean and acoustic flows are deflected into resonator cavity 20 during the inflow half-cycle. Very close to resonator face plate 100, acoustic and mean flows are assumed to be pumped into resonator cavity 20 through a spherically shaped thin wedge. Alternately, other in-flow shapes could be used to model the in-flow other than a spherical shape, such as a curvilinear shape, but the mathematics would be substantially more complicated.

The spherical wedge is defined by inner and outer radii denoted, respectively, as H_{end} and H_{far} and arc lengths Δθ and Δφ. The outer radial distance, H_{far}, represents the location that the model empirically predicts of the far-field acoustic pressure, which drives the grazing flow and acoustic velocities into resonator cavity 20 during the in-flow half-cycle. The inner radial distance, H_{end}, represents the effective spherical model location where the acoustic volume in-flow is pumped into the resonator cavity 20 over a dynamically steady-state acoustic period. Physically, H_{end} represents the total mass excited by the incident sound pressure. This includes the mass within resonator orifice 30 thickness, τ, and the end correction mass exterior to resonator orifice 30 thickness. The wedge model is dependent upon calibration of the above four model-derived empirical parameters, H_{end}, H_{far}, Δθ and Δφ, using test data.

Assuming incident periodic sound, the impedance Zᵣₑₛ of resonator cavity 30 is:

$${Z}_{res} = {ρ}_{m} ( \frac{{\hat{I}}_{v 0}}{{C}_{end} σ {\hat{f}}_{end}} + \frac{{κ}_{vis} {v}_{m} τ}{{d}_{ori}^{2}} ) - i {ρ}_{m} {c}_{m} cot ( \frac{2 π f {L}_{cav}}{{c}_{m}} )$$

where the various terms are defined below:

cₘ speed of sound

dₒᵣᵢ resonator orifice 30 diameter

f(ξ) polar function that calculates the radial acoustic velocity, qᵣ

f sound frequency

H_{end} spherical model location defined in FIG. 3.

H_{far} spherical model location defined in FIG. 3.

H_{mid} spherical model location defined as 0.5(H_{far}+H_{end})

L_{cav} resonator cavity depth

κᵥᵢₛ orifice 30 frictional loss parameter

ρₘ fluid density

cₘ fluid speed of sound

σ ratio of orifice to cavity area

vₘ fluid kinematic viscosity

The expression \hat{l}ᵥ₀ is defined as:

$${\hat{I}}_{v o} ≡ {\int }_{{H}_{end}}^{{H}_{tar}} \{ \begin{matrix}- ( \frac{{v}_{m}}{{r}^{2}} ) {f}_{mid}^{″} ( ξ , {H}_{mid} ) + [ \frac{ξ}{r} {V}_{∞} ( r , ξ ) - \frac{{v}_{m}}{{r}^{2}} ξ ] {f}_{mid}^{′} ( ξ , {H}_{mid} ) + \\ [ \frac{2 {V}_{∞} ( r , ξ )}{r} - \frac{\partial {V}_{∞} ( r , ξ )}{\partial r} + i \frac{ω}{{r}^{2}} ] {f}_{mid} ( ξ , {H}_{mid} )\end{matrix} \} d r$$

The polar function is space-averaged over the radial distance and is defined as:

$${f}_{mid}^{m} ( ξ ) - ( \begin{matrix}\frac{{H}_{mid} {V}_{ss}}{{v}_{m}} sin ξ + \\ tan ξ\end{matrix} ) {f}_{mid}^{″} ( ξ ) - [ \begin{matrix}( 3 \begin{matrix}\frac{{H}_{mid} {V}_{ss}}{{v}_{m}} - \\ \frac{{H}_{mid}^{2}}{{v}_{m}} \frac{\partial {V}_{ss}}{\partial r}\end{matrix} ) cos ξ + \\ \begin{matrix}\frac{{H}_{mid}}{{v}_{m}} \frac{\partial {V}_{ss}}{\partial r} sin ξ + \\ {csc}^{2} ξ - 6 + \frac{i ω {H}_{mid}^{2}}{{v}_{m}}\end{matrix}\end{matrix} ] {f}_{mid}^{′} ( ξ ) - [ ( 2 \begin{matrix}\frac{{H}_{mid}}{{v}_{m}} \frac{\partial {V}_{ss}}{\partial ξ} - \\ \frac{{H}_{mid}^{2}}{{v}_{m}} \frac{{\partial }^{2} {V}_{ss}}{\partial ξ \partial r}\end{matrix} ) cos ξ - ( \begin{matrix}\frac{{H}_{mid}^{3}}{{v}_{m}} \frac{{\partial }^{2} {V}_{ss}}{\partial {r}^{2}} - \\ \frac{{H}_{mid}^{2}}{{v}_{m}} \frac{\partial {V}_{ss}}{\partial r}\end{matrix} ) sin ξ ] {f}_{mid} ( ξ ) = 0 \\ where {H}_{mid} = ( \frac{{H}_{end} + {H}_{far}}{2} )$$

and the expression \hat{f}_{end} is defined as;

$${\hat{f}}_{end} = \frac{1}{Δ ξ} {\int }_{0}^{Δ ξ} {f}_{end} ( ξ ) d ξ$$

The polar function f_{end}(ξ), evaluated at r=H_{end}, is defined as:

$${f}_{end}^{m} ( ξ ) - ( \begin{matrix}\frac{{H}_{end} {V}_{ss}}{{v}_{m}} sin ξ + \\ tan ξ\end{matrix} ) {f}_{end}^{″} ( ξ ) - [ \begin{matrix}( 3 \begin{matrix}\frac{{H}_{end} {V}_{ss}}{{v}_{m}} - \\ \frac{{H}_{end}^{2}}{{v}_{m}} \frac{\partial {V}_{ss}}{\partial r}\end{matrix} ) cos ξ + \\ \begin{matrix}\frac{{H}_{end}}{{v}_{m}} \frac{\partial {V}_{ss}}{\partial r} sin ξ + \\ {csc}^{2} ξ - 6 + \frac{i ω {H}_{end}^{2}}{{v}_{m}}\end{matrix}\end{matrix} ] {f}_{end}^{′} ( ξ ) + [ ( 2 \begin{matrix}\frac{{H}_{end}}{{v}_{m}} \frac{\partial {V}_{ss}}{\partial ξ} - \\ \frac{{H}_{end}^{2}}{{v}_{m}} \frac{{\partial }^{2} {V}_{ss}}{\partial ξ \partial r}\end{matrix} ) cos ξ - ( \begin{matrix}\frac{{H}_{end}^{3}}{{v}_{m}} \frac{{\partial }^{2} {V}_{ss}}{\partial {r}^{2}} - \\ \frac{{H}_{end}^{2}}{{v}_{m}} \frac{\partial {V}_{ss}}{\partial r}\end{matrix} ) sin ξ ] {f}_{end} ( ξ ) = 0$$

Finally, the end correction coefficient, C_{end}, represents the ratio of the end correction area, S_{end}, to the orifice area, Sₒᵣᵢ, is defined as:

$$\begin{matrix}{C}_{end} ≡ \frac{{N}_{ori} {S}_{end}}{{N}_{ori} {S}_{ori}} = \frac{{S}_{end}}{{S}_{ori}} \\ = \frac{( {H}_{end} Δ ξ ) ( {H}_{end} Δ φ )}{π {d}_{ori}^{2} / 4} \\ = \frac{4 Δ ξ Δφ}{π} {( \frac{{H}_{end}}{{d}_{ori}} )}^{2}\end{matrix}$$

In the preferred embodiment of the present invention, resonator impedance of cavity 20 is calculated using the following Matlab code:

% 12/13/2011, this code is written to average the 12/13 version of Alan’s
% DE over r, from Hend to Hfar and then calculate the value of f along
% that interval
clear all
close all
tic;
%%%%%%%%%%%%%%%%%%%%%%%%%%%%%%%%%%%%%%%%%%%
% WEDGE RESONATOR IMPEDANCE MATLAB CODE
% This code calculates the impedance of a specified resonator geometry.
% Four parameter inputs are required consisting Hendcorr and Hfarcorr
% and phi and z(j), polar angle
% The frequencies of the data must be entered into the code.
% The value of each frequency is determined by assuming u = 1 represents
% the first frequency, u = 2, the second frequency, etc.
% While the code is generally stable, singularities are sometimes
% encountered. The singularities can be countered by increasing
% the step-size and/or reducing the iteration count.
% It is believed that the singularities are a result of using the
% built-in boundary value solver in MATLAB. This is because the
% built-in software does not make an effort to calculate the stability
% range of either the step size or the iteration count and uses a
% solution algorithm that is incompatible with certain combinations
% of these parameters.
%%%%%%%%%%%%%%%%%%%%%%%%%%%%%%%%%%%%%%%%%%%
% Input common geometry and acoustic properties
clear
tstart=now;
colorlist = [‘r’,‘b’,‘g’,‘c’,‘m’,‘k’];
% End correction parameters
jmax = 1; % number of iterations in each of three paramter loops, phi, Hend, Hfar
iter = 1; % number of iterations in each of three paramter loops, phi, Hend, Hfar
SORTnum = 1; % desired number of parameters to view
tot = 1;
vault = zeros(jmax,8);
f = [1000

1100
1200
1300
1400
1500
1600
1700
1800
1900
2000
2100
2200
2300
2400
2500]; % Sound Frequency

```
datam = textread(‘data140_4.txt’); % Frequency, Rm, Xm, measured data
Lsearch = size(datam);
num = 1; % counter for “record” row number
%%
Tstart = tic;
for l = 1:iter % iter % phi
  phi(l) = 7.4*(1 + 0.02*l)*pi/180; %
  for n=1:iter %% Hfar(n)
```

for m = 1:iter%%iter %% Hend(m)

for u = 9:9 % u value controls frequency input

if datam(u,1)/f(u) ==1

Rm = datam(u,2);
Xm = datam(u,3);
break

else

Rm = 0;
Xm = 0;

end

| end | |
|---|---|
| omega | = 2*pi*f(u); % sound radian frequency |
| Hendcorr | = 6.3*(1 + 0.02*m); % = Hend/dori, %% Do loop |
| Hfarcorr | = 9.*(1 + 0.02*n); % = Hfar/dori, %% Do loop |

| | |
|---|---|
| Kvis | = 10.25; % viscous parameter |

| | |
|---|---|
| epsilon | = 1; |

| % Input NASA Measured Boundary Layer Profile for M = 0.3 | |
|---|---|
| M | = 0.4; % grazing flow Mach No. |

| %% Input Cavity Geometry, Fluid and Acoustic Properties | | |
|---|---|---|
| E | = 2.54; | |
| T | = 60; | |
| c | = 49.03*E*12*sqrt(459.6+T); % speed of sound | |
| V | = c*M; | % Grazing Flow Speed |
| rho | = 0.0012*68/T; | % fluid density |
| nu | = 0.1165 + 0.0005107*T; | % fluid kinematic viscosity |
| dN | = 0.038*E; | % orifice diameter |
| tau | = 0.0324*E; | % face-plate thickness |
| Lcav | = 1.5*E; | % cavity depth |
| Scav | = 0.12178*E\hat{ }2; | % Area of Hexagon |
| sigma | = 0.0887; | % Peforate % open area |
| Sori | = pi*dN\hat{ }2/4; | % Perforate Area |
| N | = sigma*Scav/Sori; | % number of orifices; |

| | |
|---|---|
| V | = c*M; |

| | |
|---|---|
| Hend(m) | = Hendcorr*dN; |

| | |
|---|---|
| Hfar(n) | = Hfarcorr*dN; |
| SPL | = 140; |
| Pd | = 0.0002*sqrt(2)*10\hat{ }(SPL/20); |
| kLcav | = omega*Lcav/c; |

%% Input all terms req'd to use ODE45 to calculate the function f0
mu = 0;
aa = 8.1273e3;
bb = 3.244e−7;
K1 = 3.142e3;
for j = 1:jmax; % Do-Loop to increment angle zeta labeled z(j)

z(j) = 9.20*(1 + 0.02*j)*pi/180;
r1i = linspace(Hend(m),Hfar(n)); % discretized r values between Hend and

Hfar

| | |
|---|---|
| Cend(j) | = 4*z(j)*phi(l)/pi*(Hend(m)/dN)\hat{ }2; |

%

| D = 1 + aa.*r1i.*sin(z(j))− bb.*(r1i.*sin(z(j))).\hat{ }2; % note: r = Hend(m) | |
|---|---|
| gc = 1; | |
| Vss | = K1*log10(D); % Boundary-Layer Velocity in cm/sec % Original |

Oct_13, debug for Averaging, %% Added 12/13/2011

| | |
|---|---|
| dVdz | = gc.*K1.*(aa.*cos(z(j)) − 2.*bb.*(r1i.\hat{ }2).*sin(z(j)).*cos(z(j)))./D; |
| dVdr | = gc.*K1.*(aa.*sin(z(j)) − 2.*bb.*r1i.*(sin(z(j)).\hat{ }2))./D; |
| tmp1 | = (aa−4.*bb.*r1i.*sin(z(j)).*cos(z(j))); |
| tmp2 | = aa−2.*bb.*r1i.*sin(z(j)).\hat{ }2; |
| tmp3 | = K1.*sin(z(j))./D; |
| d2Vdrdz | = gc.*(K1.*cos(z(j))./D).*(tmp1 − tmp3.*tmp2); |
| d2Vdr2 | = −gc.*(K1.*sin(z(j).\hat{ }2)./D).*(2.*bb + (aa- |

2.*bb.*r1i.*sin(z(j)).\hat{ }2./D));
% IF the section to the next B1 is active, you are evaluating the
% equations where r = Hend

Q(j) = sin(z(j))*Vss(j)*Hend(m)/nu+tan(z(j));
R1(j) = cos(z(j))*(3*Vss(j)*Hend(m)/nu−(Hend(m)\hat{ }2/nu)*dVdr(j));
R2(j) = sin(z(j))*Hend(m)*dVdz(j)/nu + csc(z(j))\hat{ }2 − 6 +

1i*omega*Hend(m)\hat{ }2/nu;

R(j) = R1(j) + R2(j):
S1(j) = cos(z(j))*(2*Hend(m)*dVdz(j)/nu − (Hend(m)\hat{ }2/nu)*d2Vdrdz(j));
S2(j) = sin(z(j))*((Hend(m)\hat{ }3/nu)*d2Vdr2(j)−(Hend(m)\hat{ }2/nu)*dVdr(j));
S(j) = S1(j) − S2(j); %% Original Oct_13, debug for Averaging

% IF the next section is active then r = Hmid

Hmid(m) = (Hend(m)+Hfar(n))/2;
Qmid(j) = sin(z(j))*Vss(j)*Hmid(m)/nu+tan(z(j));
R1mid(j) = cos(z(j))*(3*Vss(j)*Hmid(m)/nu−(Hmid(m)\hat{ }2/nu)*dVdr(j));
R2mid(j) = sin(z(j))*Hmid(m)*dVdz(j)/nu + csc(z(j))\hat{ }2 − 6 +

1i*omega*Hmid(m)\hat{ }2/nu;

Rmid(j) = R1mid(j) + R2mid(j);
S1mid(j) = cos(z(j))*(2*Hmid(m)*dVdz(j)/nu − (Hmid(m)\hat{ }2/nu)*d2Vdrdz(j));
S2mid(j) = sin(z(j))*((Hmid(m)\hat{ }3/nu)*d2Vdr2(j)−(Hmid(m)\hat{ }2/nu)*dVdr(j));
Smid(j) = (S1mid(j) − S2mid(j)); %% Original Oct_13, debug for Averaging

% If the section between the next A1 is active, then you are using the
% averaged R values

averageCheck = 1; %% If == 1, gradients are active, if ==0, gradients are not

accounted

IQ = sin(z(j)).*Vss.*r1i/nu+tan(z(j));
Qavg(j) = 1/(Hfar(n)−Hend(m))*trapz(r1i,IQ);
IR1 = cos(z(j))*(3.*Vss.*r1i/nu−(r1i.\hat{ }2/nu)*dVdr(j));
R1avg(j) =1/(Hfar(n)−Hend(m))*trapz(r1i,IR1);
IR2 = sin(z(j)).*r1i*dVdz(j)/nu + csc(z(j))\hat{ }2 − 6 + 1i*omega.*r1i.\hat{ }2/nu;
R2avg(j) = 1/(Hfar(n)−Hend(m))*trapz(r1i,IR2);
Ravg(j) = R1avg(j) + R2avg(j);
IS1 = cos(z(j))*(2.*r1i*dVdz(j)/nu − (r1i.\hat{ }2/nu)*d2Vdrdz(j));
S1avg(j) = 1/(Hfar(n)−Hend(m))*trapz(r1i,IS1);
IS2 = sin(z(j))*((r1i.\hat{ }3/nu)*d2Vdr2(j)−(r1i.\hat{ }2/nu)*dVdr(j));
S2avg(j) = 1/(Hfar(n)−Hend(m))*trapz(r1i,IS2);
Savg(j) = S1(j) − S2(j);

% A1
% The section below solves the differential equation for f

out5 = bvpexample_3(Qmid(j),Rmid(j),Smid(j),z(j)); %% r = Hmid

% R == Hmid, This must be the only R section active if you are looking at
% the case where R == Hmid.

rint = linspace(Hend(m),Hfar(n),length(out5.x));
D2 = 1 + aa.*rint.*sin(z(j))− bb.*(rint.*sin(z(j))).\hat{ }2; % recalcuation of size

appropriate Vss based on favg

Vss2 = 1480*log(D2); % Boundary-Layer Velocity in cm/sec %%

recalcuation of size appropriate Vss based on favg

dVdr2 = (K1.*(aa.*sin(z(j)) − 2.*bb.*rint.*sin(z(j)).\hat{ }2))./(−

bb.*rint.\hat{ }2.*sin(z(j)).\hat{ }2 + aa.*rint.*sin(z(j)) + 1); % dV/dr, recalc for favg

favg = out5.y(1,:); %% Favg
f_prime = out5.y(2,:); %% Favg
f_dblprime = out5.y(3,:); %% Favg
fhat(j) = (1/z(j))*(trapz(out5.x,out5.y(1,:))); %% f\hat{ }, @Hend
% If1 = (1i*omega./(rint.\hat{ }2)+2./(rint).*Vss(j)−dVdr(j)−

nu./rint.\hat{ }2*z(j)).*f0+(z(j)./rint.*Vss(j)).*f_prime+(nu./rint.\hat{ }2).*f_dblprime;

If1 = −(nu./rint.\hat{ }2).*f_dblprime + (z(j)./rint.*Vss2−nu./rint.\hat{ }2.*z(j)).*f_prime +

(2*Vss2./rint−dVdr2+1i*omega).*favg;

I(j) = trapz(rint,If1); %% I\hat{ }, based on ravg
% % plot(xi,real(If1))
Z(j) = (Hend(m)\hat{ }2*I(j)/(c*sigma*Cend(j)*fhat(1,j))−1i*cot(kLcav));

% End R == Hmid

Rp = real(Z(j));
Xp = imag(Z(j));
tmp1 = (1−abs(Rp/Rm))\hat{ }2 + (1−abs(Xp/Xm))\hat{ }2;
Diff(j) = sqrt(tmp1);
vault(j,:) =

[Hend(m)/dN.Hfar(n)/dN.phi(l)*180/pi.z(j)*180/pi,Cend(j),Diff(j),Rp,Xp];

end
[C,l] = min(vault(:,6)); % searches for location and value of minimum difference

paramter

record(num,:) = vault(l,:);
num = num+1; %% 12/13/debug integral

end

end
end
time = cputime/60;
fprintf(‘ Hend/dN, Hfar/dN, phi, zeta, Cend, Diff, Rp, Xp’)
phi(l) = phi(l)*1.1;
SORTrecord = sortrows(record,6);
SORTrecord(1:SORTnum,:)
averagetime = toc;

Various other modifications may be made to that depicted in the various drawings of the preferred embodiment of the present invention without departing from the spirit and scope of the invention. Accordingly, the invention is not to be limited by the preferred embodiment shown in the various drawings, the MatLab code, and otherwise described herein, but by the scope of the claims.

1. A process for designing an acoustic liner for quieting a jet engine having a plurality of resonators comprising the steps of:
determining an optimized resonator having a desired, optimized wall impedance tailored towards a jet engine;
employing an acoustic near-field physical model of the acoustic, mean-flow field pumped into a resonator that takes into account conservation of mass and momentum; and
calibrating the acoustic near-field physical model by testing in a grazing flow the acoustic impedance of a suitable number of resonators having different geometries to derive empirical expressions for the acoustic near-field physical model.

2. The process for designing an acoustic liner of claim 1 having the additional step of validating the accuracy of the acoustic near-field physical model by comparing its predicted impedance to resonator test data supplied by a nacelle liner manufacturer.

3. The process for designing an acoustic liner of claim 1 in which the acoustic near-field physical model comprises:
three physical dimensions; and
four empirical parameters that define the volume of the near-field physical model: a first location of the far-field driving acoustic pressure; a second location wherein the acoustic-mean-flow is pumped into and out of the resonator volume; and
two angular parameters that, together with the difference between the first and second locations define the volume, that is pumped into and out of the resonator cavity;
wherein the step of calibrating the acoustic-near field physical model further includes:
deriving empirical expressions for the four parameters; and
inserting the four parameters into the acoustic-near field physical model to determine the impedance of an resonator to match as close as practical the desired impedance.

4. The process for designing an acoustic liner of claim 3 in which the acoustic liner has a nacelle wall, and the acoustic near-field physical model includes accounting for mean flow near the nacelle wall.

5. The process for designing the acoustic liner of claim 4 in which the acoustic near-field physical model is a spherical in-flow model.

6. The process for designing the acoustic liner of claim 5 in which the spherical in-flow model is a spherical-shaped wedge that pumps fluid into and out of the resonator cavity.

7. The process for designing an acoustic liner of claim 6 having the additional step of validating the accuracy of the acoustic near-field physical model by comparing its predicted impedance to resonator test data supplied by a nacelle liner manufacturer.

8. The process for designing the acoustic liner of claim 5 in which the acoustic near-field physical model only models the in-flow half cycle into the resonator.

9. A method of manufacturing an acoustic liner for use in jet aircraft engines comprising the steps of:
attaching a rigid back plate to a honeycomb structure comprised of a plurality of resonators; and
attaching a front resistance plate having a plurality of orifices to the honeycomb structure opposite the rigid back plate, thereby forming a geometry including the orifice size and the dimensions of each resonator;
wherein the geometry of the resonators and orifices are determined by:
determining an optimized resonator having a desired, optimized wall impedance tailored towards a jet engine;
employing an acoustic near-field physical model of the acoustic, mean-flow field pumped into a resonator that takes into account conservation of mass and momentum; and
calibrating the acoustic near-field physical model by testing in a grazing flow the acoustical impedance of a suitable number of resonators having different geometries to derive empirical expressions for the acoustic near-field physical model.

10. The process for manufacturing the acoustic liner of claim 9 having the additional step of validating the accuracy of the acoustic near-field physical model by comparing its predicted impedance to resonator test data supplied by a nacelle liner manufacturer.

11. The process for manufacturing the acoustic liner of claim 9 in which the physical model comprises:
three physical dimensions; and
four empirical parameters: a first location of the far-field driving acoustic pressure; a second location wherein the acoustic-mean-flow is pumped into and out of the resonator volume; and two angular parameters that, together with the difference between the first and second locations, define the volume that is pumped into and out of the resonator cavity;
wherein the step of calibrating the acoustic-near field physical model further includes:
deriving empirical expressions for the four parameters; and
inserting the four parameters into the acoustic-near field physical model to determine the impedance of an optimized resonator to match as close as practical the desired impedance.

12. The process for manufacturing the acoustic liner of claim 11 in which the acoustic liner has a nacelle wall, and the physical model includes accounting for gradient velocity near the nacelle wall.

13. The process for manufacturing the acoustic liner of claim 11 in which the acoustic near-field physical model is a spherical in-flow model.

14. The process for manufacturing the acoustic liner of claim 13 in which the spherical in-flow model is a spherical-shaped wedge that pumps fluid into and out of the resonator cavity.

15. The process for manufacturing the acoustic liner of claim 14 having the additional step of validating the accuracy of the acoustic near-field physical model by comparing its predicted impedance to resonator test data supplied by a nacelle liner manufacturer.

16. The process for manufacturing the acoustic liner of claim 14 in which the acoustic near-field physical model only models the in-flow half cycle into the resonator.

17. An acoustic liner for use in jet aircraft engines comprising:
a rigid back plate;
a honeycomb layer comprised of a plurality of resonators attached to the rigid back plate; and
a front resistance plate having a plurality of orifices, where the front resistance plate is attached to the honeycomb layer opposite the rigid back plate, where each resonator and orifice has a geometry defined by their dimensions;
wherein the geometry of the resonators and orifices are determined by the outcome of applying an acoustic near-field physical model of the acoustic, mean-flow field pumped into a resonator in a grazing flow environment that takes into account conservation of mass and momentum; and
wherein the acoustic near-field physical model is calibrated to yield a geometry of the resonator such that its impedance substantially equals a desired optimized impedance for a particular jet engine.

18. The acoustic liner of claim 17 wherein the acoustic near-field physical model accounts for the gradient velocity near the front resistance plate.

19. The acoustic liner of claim 18 wherein the acoustic near-field physical model is a spherical in-flow model.

20. The acoustic liner of claim 19 wherein the spherical in-flow model is a spherical-shaped wedge that pumps fluid into and out of the resonator cavity.

21. The acoustic liner of claim 20 wherein the acoustic near-field physical model comprises
three physical dimensions; and
four empirical parameters: a first location of the far-field driving acoustic pressure; a second location wherein the acoustic-mean-flow is pumped into and out of the resonator volume; and two angular parameters that, together with the difference between the first and second locations, define the volume that is pumped into and out of the resonator cavity;
wherein the acoustic-near field physical model is calibrated to derive empirical expressions for the four parameters, and the four parameters are inserted into the acoustic-near field physical model to determine the impedance of an optimized resonator to match as close as practical the desired impedance.
